(19) United States
(12) Patent Application Publication
(10) Pub. No.: US 2005/0098007 A1
(43) Pub. Date: May 12, 2005

(54) Installation for removing shavings and remainder pieces from the desired cut material

(76) Inventors: Markus Danner, Freiburg (DE); Ralf-Jurgen Linser, March (DE); Andreas Weigel, Steffenberg (DE)

Correspondence Address: CHRISTIE, PARKER & HALE, LLP, PO BOX 7068, PASADENA, CA, 91109-7068, US

(21) Appl. No.: 10/852,292

(22) Filed: May 24, 2004

(30) Foreign Application Priority Data
May 23, 2003 (DE) 203 08 334.2

(51) Int. Cl. B26D 7/08

(52) U.S. Cl. 83/168

(57) ABSTRACT

An installation for removing shavings and remainder pieces from desired cut material after cutting by means of a circular saw with a plurality of saw blades. A conveyor belt longitudinally conveys the cut material downstream of the circular saw. One longitudinal edge of the conveyor belt is aligned with the reference line of the far-right engaged or far-left engaged saw blade. A pusher unit with stop, which can be displaced transversely with respect to the longitudinal direction of the conveyor belt, is arranged on the aligned side downstream of the circular saw.

The invention relates to an installation for removing shavings and remainder pieces from desired cut material after separation by a circular saw with two or more saw blades.

It is known that when solid wood is being cut to size, for example when cutting boards from the sawmill, waste or remainder pieces are produced in the region of the edges.

In the case of unedged-sawn material, the rough edge, or in the case of square-edged sawn material the longitudinal curvature, of the board must be completely removed. This produces shavings with a very wide range of geometries and sizes.

The shavings may be solid or wedge-shaped ranging from a width of zero to several centimeters and may break up into a number of parts. Also, in the case of boards which are wider than the maximum cut width of the saw, remainder pieces may be produced on one side which are so wide that a further lath can be cut. These remainder pieces then have to be returned to be drawn in upstream of the saw in order to be cut again.

In general terms, shavings and remainder pieces have to be separated from the cut straight edge or other desired products, such as laths.

In the case of relatively small cutting installations, this is done by manually sorting the desired cut parts from the remainder.

Furthermore, it is known for shavings and remainder pieces to be separated partially automatically from the straight edges or laths in installations which have mechanized components for supplying and removing the material upstream and downstream of the circular saw, in order to achieve a higher quantitative throughput and to make the operators' work easier.

The abovementioned installations predominantly use splitting wedges which are arranged directly in the cut gap downstream of the saw blade. The splitting wedges laterally divert the shavings and remainder pieces.

In other installations, the shavings and remainder pieces are separated off by means of lugs which project beyond the conveyor belts, with the cut material being laid on the lugs. Shavings and the remainder pieces come to lie outside the lugs and are removed via transverse chains.

In the case of installations using a splitting wedge, it is likely that during the separation operation internal stresses in the wood would be released and the shavings or remainder pieces and/or the desired cut material may become considerably bent or distorted. This causes the cut material to strike the front of the splitting wedges, which can cause the wood to become jammed in the installation or to tear off the splitting wedge. It is also possible for the cut gap to close up, with the result that the material to be cut is not cleanly separated as it is lowered, and the shavings are carried away incorrectly.

If mechanized components are used, the cut material is preferably conveyed away on roller tracks downstream of the saw. In this instance, short, narrow shavings or remainder pieces or lath parts which have broken off may drop between the rollers and block subsequent laths. The result is that the installation has to be stopped in order to eliminate the problem.

To avoid these problems, it is also known to completely cover the roller paths. In this variant, there is a risk of relatively small splinters or pieces of bark remaining on the cover, which subsequent laths will run onto so that they are no longer conveyed onward, which once again causes disruption to the process sequence.

In a further variant used to separate the cut material from shavings and remainder pieces, only the cut material is gripped from below by laterally displaceable longitudinal conveyor chains, so that shavings and remainder pieces can drop off to the right and left. With this installation, it is necessary for the cut material to be held continuously from above, over the entire width, by pressure rollers.

Since the installations use circular saws with blade adjustment means in order to enable different lath widths to be cut from board to board, it is necessary to adjust the chain position. This requires the conveyor chains to be free of shavings and remainder pieces over their entire length in order to enable them to be repositioned. Consequently, large distances are required between the individual boards which are to be sawn, which greatly restricts the capacity of the installation.

A general statement which applies to all the known installations is that the cut material can only be conveyed transversely on leaving the conveyor which separates shavings and remainder pieces. This means that at least double the maximum wood length has to be available downstream of the saw, i.e. the installation takes up a large amount of space.

The invention is based on the object of providing an installation for removing shavings and remainder pieces from the desired cut material after separation by a circular saw with two or more saw blades which allows a clean separation of the cut parts produced and takes up little space.

According to the invention, the installation is provided with the distinguishing features of claim 1.

According to the invention, a conveyor belt for longitudinally conveying the cut material is arranged downstream of the circular saw, the right-hand or left-hand edge of which conveyor belt is aligned with the reference line of the far-right or far-left saw blade. When the cut board is emerging, therefore, the right-hand or left-hand shaving or remainder pieces drop freely downward, whereas the cut material and the shaving or remainder piece on the other side continues to be discharged along the conveyor belt.

To remove the shavings or remainder pieces on the other side, a pusher unit with stop which can be displaced transversely over the conveyor belt is provided on the aligned side of the conveyor belt. When the rear edge of the sawn board leaves the saw, a sensor means is triggered so as to act on the pusher unit with stop. The pusher unit displaces the cut material transversely across the conveyor belt until the shaving or remainder piece drops over the other edge of the conveyor belt. When this position has been reached, the pusher unit with stop is raised and returned to the starting position.

The stop of the pusher unit is of one-part or preferably multi-part design. This enables the front part, facing the saw, of the stop to be raised again even while the laths are still present on the conveyor belt. This has the advantage that the subsequent cut material can start to move onto the conveyor belt while the rear part of the stop is still completing the positioning of the preceding batch.

It is preferable for the individual parts of the stop to be displaced transversely at different velocities, so that the front part of the stop reaches its limit position more quickly than the rear part of the stop.

The configuration of the installation according to the invention allows the minimum possible distance to be used between the boards to be cut. The capacity of the installation is then determined only by the time required for the automatic positioning of the saw blades. Since the cut material is drawn out of the saw on a conveyor belt, laths which have broken off are held in position and pushed over the conveyor belt in a defined way. There is no disruption to the process sequence.

The invention is to be explained in more detail below with reference to the drawings and on the basis of an exemplary embodiment. In the drawings:

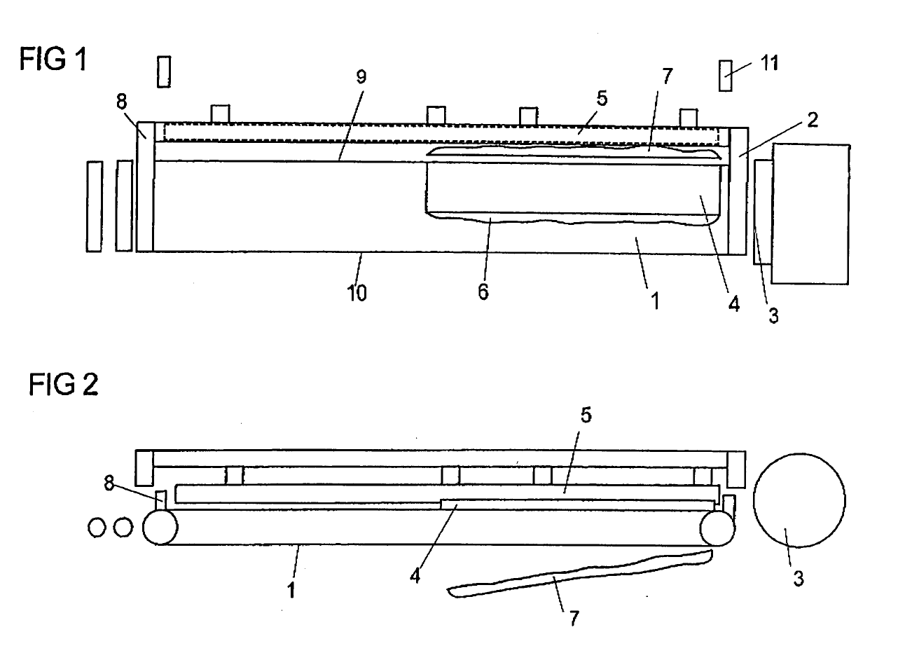

FIG. 1 shows a plan view of the installation according to the invention prior to the transverse displacement of the cut material;

FIG. 2 shows a side view of the installation from FIG. 1;

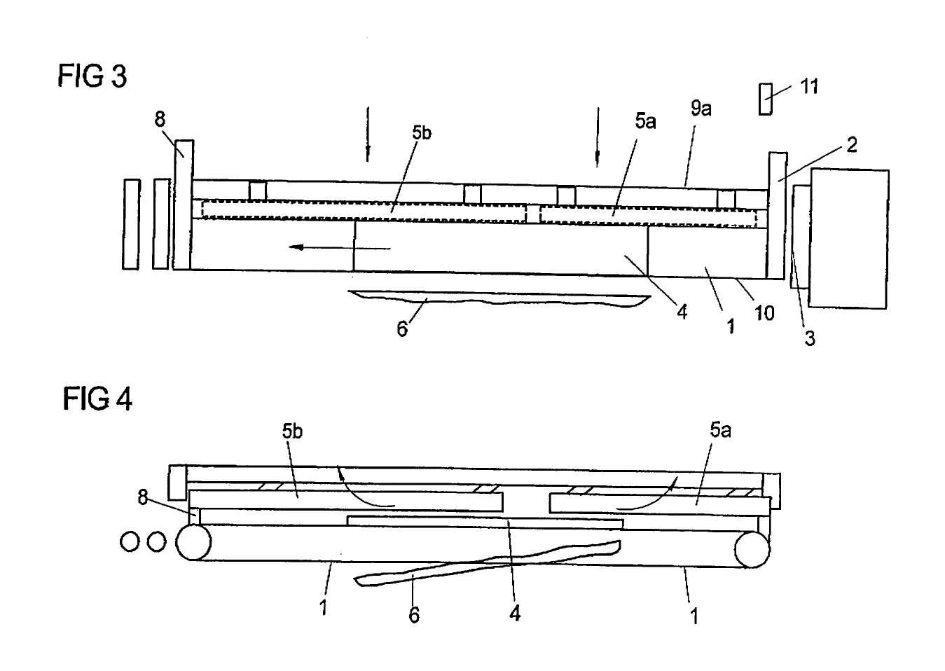

FIG. 3 shows a plan view of the installation after the transverse displacement of the cut material;

FIG. 4 shows a side view of the installation shown in FIG. 3.

In the installation illustrated in the figures, the edge 9 of the conveyor belt 1 is aligned with the reference line of the circular saw 3. During sawing, the cut material 4 moves onto the conveyor belt and is discharged. The shaving 7 produced on the right-hand side of the cut material drops down over the edge 9. The installation has transverse guides 2, 8.

When the rear edge of the sawn material 4 leaves the circular saw 3, a pulse from the sensor means 11 causes a pusher unit with stop 5 to be displaced from the right to the left, transversely with respect to the running direction of the conveyor belt 1. In the process, the stop 5 pushes the cut material 4 and the shaving 6 to the edge 10 of the conveyor belt 1 until the shaving 6 drops down. At this point, the pusher unit with stop 5 is raised and moved back into its starting position.

As shown in FIGS. 3 and 4, the stop 5 may also comprise a plurality of parts, for example 5a and 5b. During the transverse displacement of the pusher unit with stop 5, the cut material 4 moves onward to the end 8 of the conveyor belt 1. The multi-part design of the stop 5 enables the front part 5a to be lifted even while the cut material 4 is still on the conveyor belt 1. In one particular configuration, the transverse displacement of the stop part 5a can be carried out more quickly than that of the subsequent stop parts, for example 5b. This has the advantage that the following board to be cut can be passed onto the conveyor belt 1 by the saw while the stop 5b is still completing the positioning of the cut material 4 from the preceding batch.

It is also possible for the edge 10 of the conveyor belt 1 to be aligned with the reference line of the saw blade 3. In this variant, the pusher unit with stop 5 must be arranged on the left-hand side of the conveyor belt 1. In this variant, therefore, the shaving 6 is discharged first, followed by the shaving 7.

1. An installation for removing shavings and remainder pieces from desired cut material after cutting by means of a circular saw with a plurality of saw blades, wherein a conveyor belt (1) for longitudinally conveying the cut material (4) is provided downstream of the circular saw (3), one longitudinal edge of which conveyor belt is aligned with the reference line of the far-right engaged or far-left engaged saw blade, and a pusher unit with stop (5), which can be displaced transversely with respect to the longitudinal direction of the conveyor belt (1), is arranged on the aligned side downstream of the circular saw (3).

2. The installation as claimed in claim 1, wherein the stop (5) is of one-part or multi-part design.

3. The installation as claimed in claim 1 or 2, wherein the pusher unit with stop (5) is designed such that it can be raised and lowered.

4. The installation as claimed in claim 1, wherein the transverse displacement of the pusher unit with the split stops (5a; 5b) is effected by the saw at a decreasing rate toward the end (B) of the conveyor belt (1).
